(19) United States
(12) Patent Application Publication
(10) Pub. No.: US 2023/0107950 A1
(43) Pub. Date: Apr. 6, 2023

(54) DEVICE FOR MANAGING VIBRATIONS OF A MOTOR VEHICLE AND ASSOCIATED METHOD

(71) Applicant: Vitesco Technologies GmbH, Regensburg (DE)

(72) Inventors: Aurélien Fraysse, Toulouse (FR); Patrick Helmer, Toulouse (FR); Marina Labalette, Toulouse (FR)

(21) Appl. No.: 17/794,749

(22) PCT Filed: Feb. 11, 2021
(86) PCT No.: PCT/EP2021/053357

§ 371 Date: Jul. 22, 2022

(30) Foreign Application Priority Data
Mar. 11, 2020 (FR) FR2002397

(51) Int. Cl. G10K 11/16; G01M 15/12; H04R 1/02; H04R 3/00; G10K 15/04; G01H 11/08

(52) U.S. Cl. CPC G10K 11/16; G01H 11/08; G01M 15/12; G10K 15/04; H04R 1/025; H04R 3/00; H04R 2499/13

(57) ABSTRACT

A vibration management device for managing the vibrations of a motor vehicle, the device including an electronic controller> The electronic controller is able to be fixed to a vibrating wall receiving vibrations from a component or set of components of the vehicle, by a fixing device including a vibration sensor, generating a vibration signal. The electronic controller includes a signal processor for processing the signal originating from the sensor, and the electronic controller is connected to a device for managing the vibrations.

### CROSS REFERENCE TO RELATED APPLICATIONS

This application is the U.S. National Phase Application of PCT International Application No. PCT/EP2021/053357, filed Feb. 11, 2021, which claims priority to French Patent Application No. 2002397, filed Mar. 11, 2020, the contents of such applications being incorporated by reference herein.

### FIELD OF THE INVENTION

The invention relates to a vibration management device for managing the vibrations of a motor vehicle and to an associated management method.

### BACKGROUND OF THE INVENTION

The invention applies particularly to internal combustion vehicles or to hybrid vehicles or even therefore to electric vehicles. In instances in which the vehicle is equipped with an internal combustion engine, the aim is generally to reduce the vibrations originating from the engine in the passenger compartment for the sake of comfort for the user. Conversely, when the vehicle is fitted with a hybrid engine or an electric motor, that is to say an internal combustion engine and an electric motor, when the electric motor is in operation, the vehicle then moves noiselessly, and this presents a danger to pedestrians or cyclists who cannot hear the vehicle. In this case, the aim is to produce a sound, artificially, in order to warn of the presence of the vehicle.

In addition, the vibrations can be caused by a faulty part, and can mean an imminent mechanical or electronic failure.

It is known from the prior art to place a vibration sensor 10 near the internal combustion engine in order to measure the vibrations coming from the engine block. Generally, the vibration sensor 10 is located on the engine block 40 (see FIG. 1). The vibration sensor 10, of the type operating with a piezoelectric element for example, or of some other type, is then connected by wire 30 to an engine computer 20, or electronic controller. This is illustrated in FIG. 1. The electronic controller 20, which is generally located far from the engine and from the vibration sensor 10, then controls, on the basis of the vibration signal received and analyzed, the settings of various actuators, in order to control, amongst other things, the injection of fuel (quantity and timing) or the quantity of air, with the aim of reducing the noise and/or vibrations resulting from the operation of the engine.

However, this noise is not representative of the noise perceived by the passengers in the passenger compartment because all the noises coming from the chassis or other components are added on top of the noise of the engine.

In the case of a hybrid or electric motor, it is desirable to generate a noise which is in line with the speed of the vehicle.

### SUMMARY OF THE INVENTION

An aspect of the present invention proposes a method for managing vibrations in the passenger compartment of a motor vehicle that overcomes the drawbacks of the prior art, that is to say that makes it possible:
a. to attenuate the noise originating from the engine compartment, in the case of the operation of an internal combustion engine, or alternatively,
b. to amplify the noise originating from the engine compartment in the case of the operation of an electric motor,
c. to identify the cause of new vibrations, and to determine a faulty engine, motor or vehicle part.

An aspect of the invention proposes a vibration management device for managing the vibrations of a motor vehicle, the device comprising an electronic controller, the device being notable in that:
a. the electronic controller is able to be fixed to a vibrating wall receiving vibrations from a component or set of components of the vehicle, by means of fixing means comprising a vibration sensor, generating a vibration signal,
b. said electronic controller comprises signal processing means for processing the signal originating from said sensor,
c. said electronic controller is connected to means for managing said vibrations.

Judiciously, the means for managing said vibrations consist of means for comparing the signal with a predetermined signature, and means for determining a faulty component or set of components on the basis of the result of said comparison.

Advantageously, the means for managing said vibrations consist of means for controlling an audio system, which means are designed to generate, amplify or attenuate the vibrations inside the passenger compartment of the vehicle on the basis of the signal originating from the sensor.

Preferably, the vibration sensor comprises an accelerometer sensor equipped with a piezo ceramic sensitive element.

Advantageously, the vibrating wall receives vibrations originating from an engine compartment or from a chassis of the vehicle.

In one embodiment, the means for controlling an audio system comprise an audio amplifier connected to audio speakers and/or a sound generator, connected to audio speakers.

Preferably:
a. the vibration sensor comprises a through hole,
b. the fixing means comprise a fixing lug and a screw,
c. said screw being designed to fix the fixing lug to the vibrating wall and to be screwed into the through hole so that a contact surface of the sensor comes into contact with a receiving surface of the vibrating wall.

An aspect of the invention applies to any internal combustion engine or electric motor, comprising a management device according to any one of the features listed above.

Finally, an aspect of the invention relates to any motor vehicle, comprising an internal combustion engine at/or an electric motor itself equipped with a management device according to any one of the features listed above.

### BRIEF DESCRIPTION OF THE DRAWINGS

Other features and advantages of aspects of the invention will become more apparent from reading the description that follows. This description is purely illustrative and should be read in conjunction with the appended drawings, in which:

FIG. 1, depicts, according to the prior art, a vibration sensor located on an engine block and connected by wire to an electronic controller,

FIG. 2 depicts an electronic controller according to an aspect of the invention,

FIG. 3 is a sectional view of a vibration sensor according to an aspect of the invention,

FIG. 4 depicts the vibration management device according to an aspect of the invention.

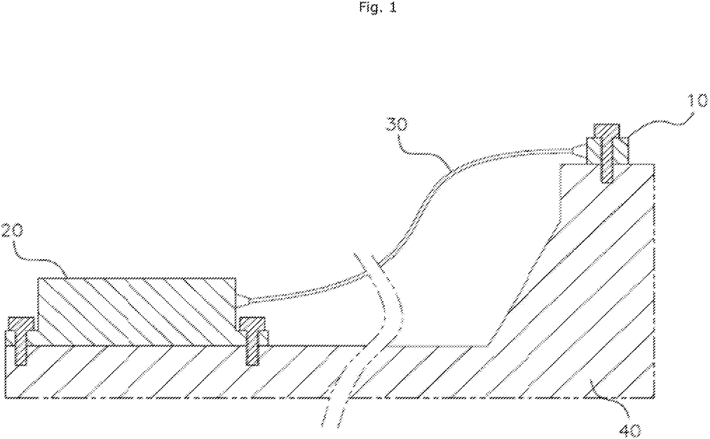

### DETAILED DESCRIPTION OF THE EMBODIMENTS

An aspect of the invention proposes a vibration management device D illustrated in FIG. 4, which comprises an electronic controller 20' connected, in this example, although this is in no way limiting, to means 21' for managing said vibrations, for example, means for controlling an audio system, for example an audio amplifier connected to audio speakers or else a sound generator, connected to audio speakers, in this case any means making it possible to amplify, generate or attenuate a sound in the passenger compartment of a motor vehicle on the basis of a vibratory signal. The means for processing an audio signal are known to those skilled in the art and will not be detailed here.

The electronic controller 20' according to an aspect of the invention comprises a printed circuit 60 itself comprising software and hardware means capable of receiving signals, by wire or wirelessly, via any known technology (inductive, infrared...), originating from components or sensors located on board the vehicle and is capable of sending control signals to actuators located on board the vehicle or to a central management unit of the vehicle or of the engine or motor or of any component or set of components located on the vehicle.

According to an aspect of the invention, the electronic controller 20' is capable of being fixed, by means of fixing means 11, for example two screws 11, screwed into supports, for example two fixing lugs 22 integral with the controller 20', to a wall 50 transmitting the vibrations originating from a component of the vehicle or from a set of components of the vehicle, and for example originating from the chassis or from the engine or motor compartment of the vehicle.

According to an aspect of the invention, and ingeniously, one of the lugs 22 comprises a vibration sensor, of the piezoelectric sensor type 10', into which a screw 11 is screwed.

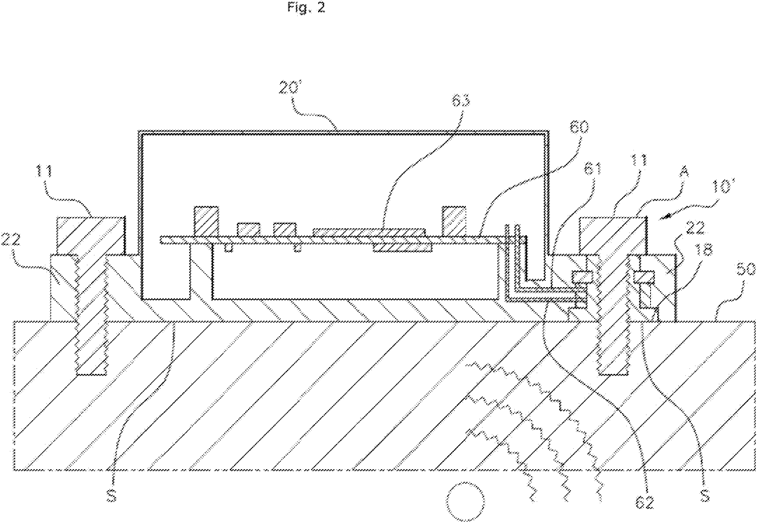

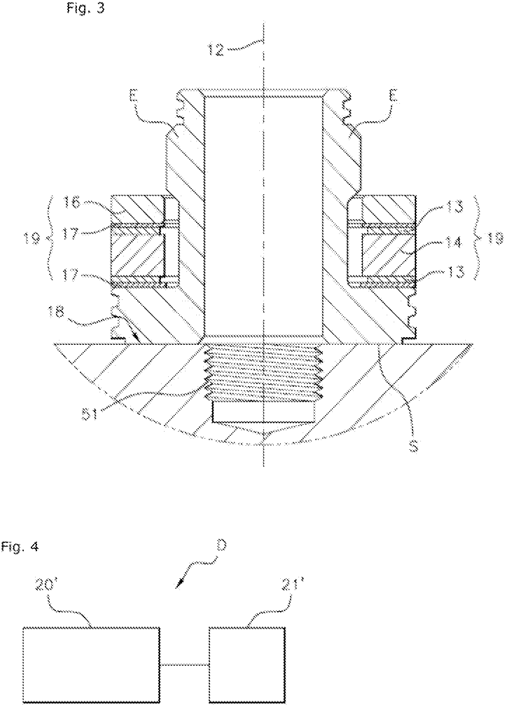

Such a sensor is depicted in FIG. 3. FIG. 3 is a sectional view showing a vibration sensor 10' positioned on the vibrating wall 50. The sensor 10' comprises a coupling screw 11 (shown in FIG. 2) designed to be screwed into a tapped bore 51 of the vibrating wall 50.

The vibrating wall 50 has a flat receiving surface S for the vibration sensor 10'. The sensor 10' also includes a planar contact surface 18 designed to come into contact with the receiving surface S.

The sensor 10' comprises a base E which is mechanically coupled, in the present example aimed at a vibration sensor, to an accelerometer sensor 19. The accelerometer sensor consists of a stack of a seismic mass 16, of an insulating washer 17, of an electrical contact washer 13, of a sensitive element consisting of a piezo ceramic ring 14, then of a second electrical contact washer 13 and of a second insulating washer 17. This type of piezoelectric sensor is known to those skilled in the art and habitually used for detecting the phenomenon of knock in gasoline internal combustion engines.

The base E has a through hole 15 extending along a fixing axis 12.

The screw 11 has a head A and a body B consisting of a threaded section in order to be screwed into the through hole 15 of the base E.

The piezoelectric sensor 10' is arranged in the lug 22 in such a way that the contact surface 18 of its base E is in contact with the receiving surface S of the wall 50 in order to transmit the vibrations received by the wall 50 to the piezoelectric element. The vibration sensor 10' is for example overmolded during the manufacture of the fixing lugs 22.

The vibration sensor 10' is connected by connectors 61, 62 at the level of the accelerometer sensor 19 to the printed circuit 60, the latter comprising signal processing means 63 for processing the signal coming from said sensor. The processing means 63 consist for example of software or components making it possible to filter vibrations, for example.

The piezo-type vibration sensor 10' thus screwed in place makes it possible to measure the vibrations received by the wall 50 and to analyze them via the processing means 61. With such an electronic controller 20' according to an aspect of the invention, there is no longer a wired connection between the vibration sensor 10' and the means 61 for processing the signal coming from said sensor. Moreover, with such an arrangement, the piezo sensor is integrated into one of the fixing lugs of the controller 20' and the fixing screw for fixing the sensor on the wall is also able to hold the controller 20' on the wall 50.

Indeed, the screw 11 is designed to fix the fixing lug 22 on the vibrating wall 50 and simultaneously to be screwed into the through hole 15 so that the contact surface 18 of the vibration sensor 10' comes into contact with the receiving surface S of the vibrating wall 50.

The signal coming from the sensor is analyzed by the processing means 61, and then transmitted to vibration management means for managing said vibrations.

The vibration management means 21' for managing said vibrations may consist of means for controlling an audio system in order either to amplify the noise perceived by the wall 50, or to attenuate the noise perceived by the wall 50 or even to generate a sound which makes it possible to attenuate the noise perceived by the wall 50.

The vibration management means 21' for managing said vibrations may equally consist of means for comparing the signal with a predetermined signature, and of means for determining a faulty component or set of components on the basis of the result of said comparison.

Indeed, the vibration signal coming from the vibration sensor 10' can be compared to signatures of vibration signals, determined beforehand for various cases of faultiness of components or of sets of components of the vehicle, of the engine or motor or of the chassis and recorded for example in a memory of said electronic controller 20'.

Thus, by making a simple comparison, using any mathematical tool available to those skilled in the art, between the vibratory signal and the predetermined signatures, it then becomes possible to determine the location and the type of part (components, or set of components) that is faulty.

An aspect of the invention makes it possible, in an ingenious way, by the use of a single piezoelectric type vibration sensor located in such a way as to measure the vibrations of a set of components with a view not only to determining that are faulty, but also to amplifying, to attenuating or to generating noise originating from the chassis or from the engine or motor compartment of a motor vehicle for the purpose of user comfort or safety.

An aspect of the invention is judicious insofar as the vibration sensor also acts as means for fixing the electronic controller against the vibrating wall by means of the fixing screw, thus eliminating any wired connection between the sensor and the controller.

1. A vibration management device for managing the vibrations of a motor vehicle, the device comprising an electronic controller, said electronic controller:
a) being able to be fixed to a vibrating wall receiving vibrations from a component or set of components of the vehicle, by fixing means comprising a vibration sensor , generating a vibration signal,
b) comprising a signal processing means for processing the signal originating from said sensor,
being connected to means for managing said vibrations, wherein:
a) the vibration sensor comprises a through hole,
b) the fixing means comprise a fixing lug and a screw,
c) said screw being designed to fix the fixing lug to the vibrating wall and to be screwed into the through hole so that a contact surface of the sensor comes into contact with a receiving surface of the vibrating wall.

2. The vibration management device as claimed in claim 1, wherein the means for managing said vibrations consist of means for comparing the signal with a predetermined signature, and means for determining a faulty component or set of components on the basis of the result of said comparison.

3. The vibration management device as claimed in claim 1, wherein the means for managing said vibrations consist of means for controlling an audio system, which means are designed to generate, amplify or attenuate the vibrations inside the passenger compartment of the vehicle on the basis of the signal originating from the sensor.

4. The vibration management device as claimed in claim 1, wherein the vibration sensor comprises an accelerometer sensor equipped with a piezo ceramic sensitive element.

5. The vibration management device as claimed in claim 1,wherein the vibrating wall receives vibrations originating from an engine compartment or from a chassis of the vehicle.

6. The vibration management device as claimed in claim 1, wherein the means for controlling an audio system comprise an audio amplifier connected to audio speakers and/or a sound generator, connected to audio speakers.

7. An internal combustion engine or electric motor, comprising a management device as claimed in claim 1.

8. A motor vehicle, comprising an internal combustion engine at/or an electric motor, and comprising a management device as claimed in claim 1.
